(19) United States
(12) Patent Application Publication
(10) Pub. No.: US 2011/0272342 A1
(43) Pub. Date: Nov. 10, 2011

(54) Food Straining Device

(76) Inventor: Margaret Lee, Clayton, NC (US)

(21) Appl. No.: 13/097,157

(22) Filed: Apr. 29, 2011

Related U.S. Application Data
(60) Provisional application No. 61/331,515, filed on May 5, 2010.

(51) Int. Cl. B01D 35/28

(52) U.S. Cl. 210/470

(57) ABSTRACT

Disclosed is a system for a food straining device. In various embodiments a food product is placed within a bowl having drainage holes or a mesh bag. A lid component is coupled with or adapted to work in conjunction with the bowl or bag such that the lid causes the food product to be compressed such that excess liquid can escape through the drainage holes or through the mesh. An optional catch bowl can be used to capture and retain the drained liquid.

### CROSS-REFERENCE TO RELATED APPLICATIONS

This Application is related to and to the extent possible claims the benefit of prior filed provisional patent application 61/331,515 FILED May 5, 2010 entitled, “Food Straining Device”.

### BACKGROUND

Spinach is one of the most versatile vegetables in cooking. It is high in nutrients and adds flavor to many dishes. Because of its popularity among cooks, spinach is mass produced and frozen in microwaveable or boil-in bags. When frozen spinach is cooked it becomes saturated with moisture in the process. This excess liquid is not wanted and must be removed prior to use. Failure to remove the excess liquid means that is incorporated into the dish being prepared. This often will ruin the desired consistency of the dish. Thus, many cooks will improvise methods for draining cooked or thawed spinach of excess liquid which can be a time consuming and messy task.

What is needed is a straining device that can quickly and conveniently drain the excess liquid form recently cooked or thawed food products. While the straining device described below is primarily described with reference to spinach, one of ordinary skill in the art can readily utilize the same device for a variety of other food products. Thus, the food straining device should not be considered to be limited to spinach only.

### SUMMARY

Embodiments of the present invention are directed toward a device for removing excess liquid form a food product such as, for instance, spinach. In one embodiment the device comprises: an upper disc that includes a plurality of mesh hooks dispersed about the perimeter, a pair of grips affixed to the top surface, and a hole bored through the center; a lower disc that includes a plurality of non-slip feet affixed to the bottom surface, a plurality of drainage holes bored through the lower disc, and a threaded hole bored through the center; a rod having an upper and lower end in which a handle is integrated into the upper end and the tip of the lower end is threaded, the rod further including a pair of disc supports capable of supporting the upper disc and a disc support release mechanism actuated by a release button integrated into the handle portion of the rod; a generally cylindrical mesh bag having upper and lower ends in which the lower end is coupled with the lower disc about its perimeter and the upper end includes a plurality of mesh coupling rings adapted to couple with the plurality of mesh hooks, wherein the rod is inserted through the hole of the upper disc and is secured in the threaded hole of the bottom disc such that the upper disc rests upon the disc supports.

In another embodiment there is disclosed and claimed a food straining device that includes a collapsible bowl having a rigid rim portion and a rigid base portion where the rigid base portion includes a plurality of drainage holes. There is also a lid component adapted to be coupled with the rigid rim portion of the bowl such that when a food product is present in the bowl and the lid is attached and downward pressure is applied to the lid the bowl will collapse and any excess liquid in the bowl can be squeezed out of the food product through the drainage holes.

The collapsible bowl can be made from silicone or another food friendly plastic material.

The bowl can also include a plurality of base supports coupled to the bottom surface of the bowl to support the food straining device above a flat surface.

The food straining device can also include an optional catch bowl adapted to receive the collapsible bowl wherein the catch bowl retains liquids that leave the collapsible bowl during operation of the device.

In yet another embodiment there is disclosed a food straining device including a rigid bowl made from a food friendly plastic or metal material having a plurality of drainage holes and a post that extends upward from the center of the base of the bowl past the top of the bowl. There is also a lid component having a hole in its center wherein the hole is adapted to fit over the post such that when a food product is present in the bowl and the lid is fit over the post and downward pressure is applied to the lid the lid will move downward along the post engaging the food product and squeezing any excess liquid in the bowl out of the food product through the drainage holes.

The bowl can also include a plurality of base supports coupled to the bottom surface of the bowl to support the food straining device above a flat surface.

The food straining device can also include an optional catch bowl adapted to receive the collapsible bowl wherein the catch bowl retains liquids that leave the collapsible bowl during operation of the device.

These and other features as well as advantages, which characterize the various embodiments of present invention, will be apparent from a reading of the following detailed description, drawings and the associated claims.

### BRIEF DESCRIPTION OF THE DRAWINGS

FIG. 1 is a perspective illustration of the food straining device.

FIGS. 2a and 2b illustrate the handle and rod of the food straining device.

FIG. 3 a side view illustration of the upper disc of the food straining device.

FIG. 4 a top view illustration of the upper disc of the food straining device.

FIG. 5 a side view illustration of the lower disc of the food straining device.

FIG. 6 a top view illustration of the lower disc of the food straining device.

FIG. 7 illustrates another embodiment of a food straining device.

FIG. 8 illustrates yet another embodiment of a food straining device.

### DETAILED DESCRIPTION OF PREFERRED EMBODIMENTS

Referring now to the drawings, in which like numerals represent like elements, exemplary embodiments of the present invention are described herein.

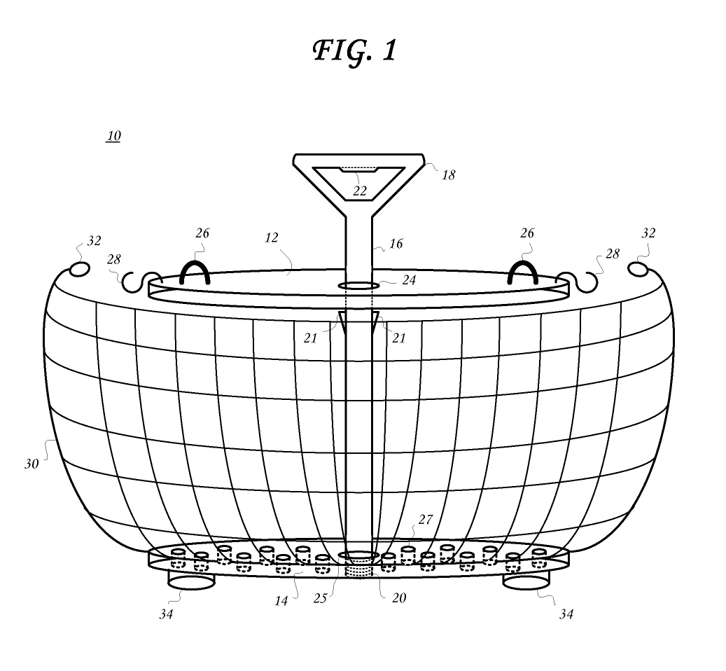

FIG. 1 is a perspective illustration of the food straining device 10. The device 10 is generally comprised of four components including an upper disc 12, a lower disc 14, a handle 18/rod 16 mechanism, and a mesh bag 30. These components can easily be assembled and disassembled for easy cleaning and storage. The upper disc 12 and lower disc 14 each include a hole 24 and 25 respectively that permit the handle 18/rod 16 mechanism to fit through. The handle 18/rod 16 mechanism is threaded 20 (like a bolt) at its lower end and can be screwed into hole 25 of lower disc 14 since hole 25 is similarly threaded. The lower disc 14 can also include a plurality of drainage holes 27 as well as a plurality of non-slip feet 34.

Mesh bag 30 is permanently coupled about the outer perimeter of lower disc 14 and can be extended away from lower disc 14. The upper edge of the mesh bag includes a plurality of mesh coupling rings 32 that can be secured to a corresponding set of mesh hooks 28 dispersed about the outer perimeter top surface of the upper disc 14.

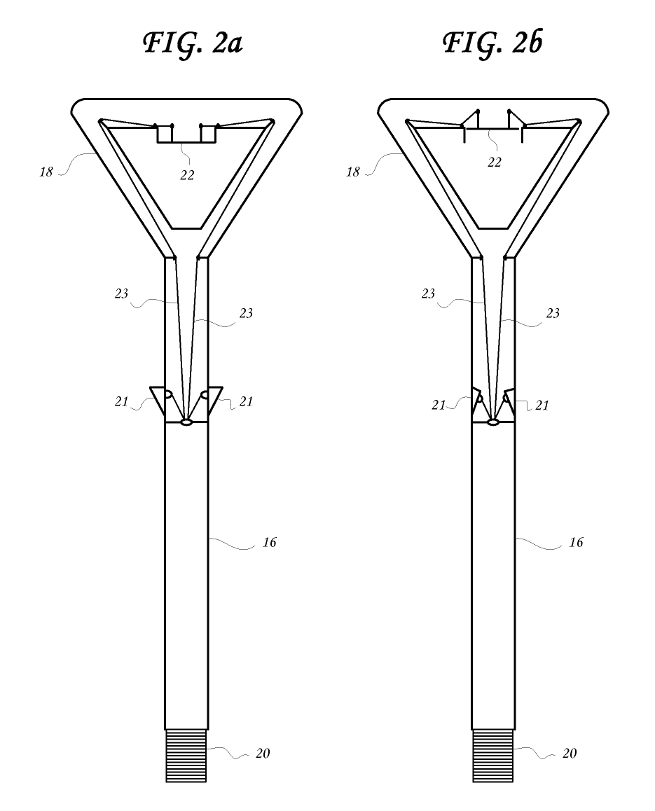

FIGS. 2a and 2b illustrate the handle 18 and rod 16 of the food straining device 10. The handle 18 and rod 16 are integrated into a single piece. The handle 18 shown is in the general shape of a triangle. This is illustrative and should not be considered limiting to the invention as one of ordinary skill in the art could vary the handle shape without altering its function. The handle facilitates pick up and transfer of the device 10. In addition, the handle also includes a release button 22 that serves to control a pair of disc supports 21 that are positioned along rod 16. The disc supports 21 serve to hold the upper disc 12 away from lower disc 14 so that there is sufficient space to place a food product to be strained in the device 10. The mechanism that operates the disc supports shown here includes a pair of cables 23 that are coupled on one end to the disc support(s) 21 and on the other end to the release button 22. When the release button 22 is compressed, the action causes cables 23 to be pulled upward which, in turn, causes the disc support(s) 21 to be pulled into the interior of rod 16 thus allowing upper disc 12 to slide past disc supports 21 and down rod 16 toward lower disc 14.

The bottom end of rod 16 is shown threaded 20 like that of a bolt. The threaded end 20 is adapted to couple with a corresponding threaded hole 25 in the lower disc 14.

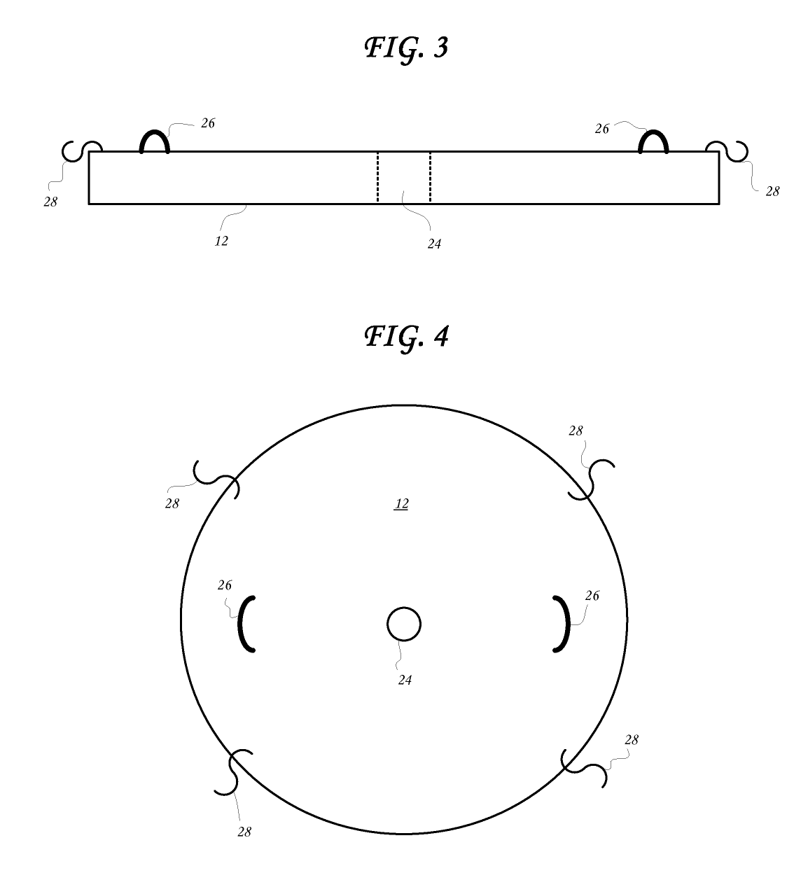

FIG. 3 a side view illustration of the upper disc 12 of the food straining device 10. In this illustration the upper disc 12 includes mesh hooks 28 that are adapted to receive corresponding mesh coupling rings 32. The mesh rings 32 are shown as having an “S” configuration. This is illustrative and should not be considered limiting to the invention as one of ordinary skill in the art could vary the hook shape without altering its function. Also shown are a pair of grips 26 that are affixed to the top surface of the upper disc 12. These grips 26 assist a user when rotating the upper disc 12. The grips 26 are shown as having an inverted “U” configuration. This is illustrative and should not be considered limiting to the invention as one of ordinary skill in the art could vary the grip shape without altering its function. A hole 24 has been bored through the center of upper disc 12 to allow for rod 16 to pass through.

FIG. 4 a top view illustration of the upper disc 12 of the food straining device 10. In this illustration the same components described with respect to FIG. 3 above are present. A plurality of mesh hooks 28 are dispersed about the outer perimeter of upper disc 12. A pair of grips 26 are affixed on the top surface of upper disc 12 and hole 24 is shown boring through the middle of upper disc 12.

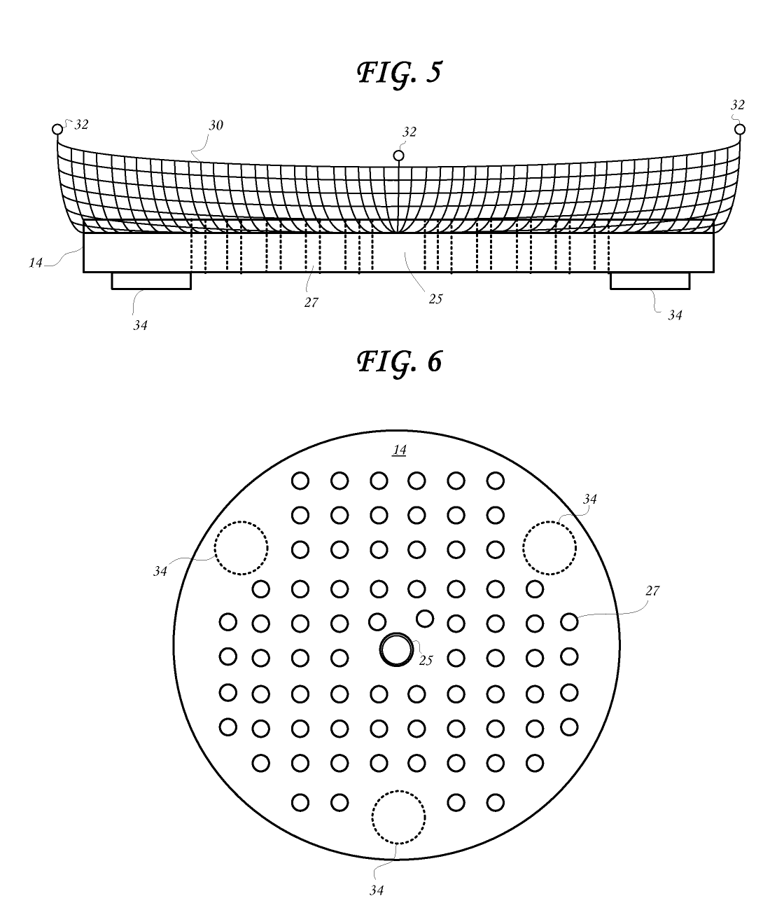

FIG. 5 a side view illustration of the lower disc 14 of the food straining device 10. Bottom disc 12 includes a plurality of holes 27 that bore through its surface. These holes 27 facilitate and allow excess liquid to drain away from the food product during operation. A plurality of non-slip feet 34 are dispersed about the bottom surface of lower disc 14 to provide a stable base when the device 10 is in operation. A threaded hole 25 bores into (or through) the center of lower disc 14 and is adapted to securely receive rod 16. The mesh bag 30 is generally cylindrical in shape. The bottom of the cylinder is affixed about the outer perimeter of the lower disc 14. The mesh bag 30 includes a plurality of mesh coupling rings 32 adapted to connect with the corresponding mesh hooks 28 affixed to the upper disc 12. Once the mesh bag 30 is hooked to the upper disc 12, an interior chamber for holding a food product results.

FIG. 6 a top view illustration of the lower disc 14 of the food straining device 10. In this illustration most of the same components described with respect to FIG. 5 above are present. These include drainage holes 27, threaded hole 25 and non-slip feet 34.

To assemble and operate the food straining device 10, the user first inserts handle 18/rod 16 mechanism through the upper disc 12 via hole 24. The threaded end 20 of handle 18/rod 16 mechanism is then secured to the lower disc 14 via a threaded coupling with hole 25. Next, the user can place the food to be strained within the confines of mesh bag 30. The mesh bag 30 is then secured to the upper disc 12 by hooking mesh coupling rings 32 over mesh hooks 28. At this point, the upper disc 12 is spaced apart from the lower disc 14 and is resting upon the disc supports 21 and the device 10 is ready for operation.

There are two steps to straining the excess liquid from the food. The first step is to twist or rotate the upper disc 12 using grips 26 on the top surface of upper disc 12. Rotating the upper disc 12 causes the mesh bag 30 to contract around the food contained therein. Once the mesh bag 30 can not be twisted any further, the user presses the release button 22 on handle 18 to draw the disc supports 21 into rod 16. This action permits the upper disc 12 to move downward along the rod 16 toward the lower disc 14. The user simply pushes down on the upper disc 12. As upper disc 12 converges on lower disc 14, the excess liquid is squeezed out the sides of the mesh bag 30 and out of holes 27 in lower disc 14.

The upper disc can be retracted up along rod 16 until it clears and rests again on disc supports 21. Top disc 12 can be rotated in the opposite direction until the mesh bag 30 is no longer twisted. The mesh bag 30 can be unhooked from the upper disc 12 and the strained food can be removed.

The user can continue to disassemble the device 10 to make it easier to clean. The various components that comprise device 10 can be made from metal, plastic, or a combination of both. The device can be made dishwasher safe for additional easy clean-up.

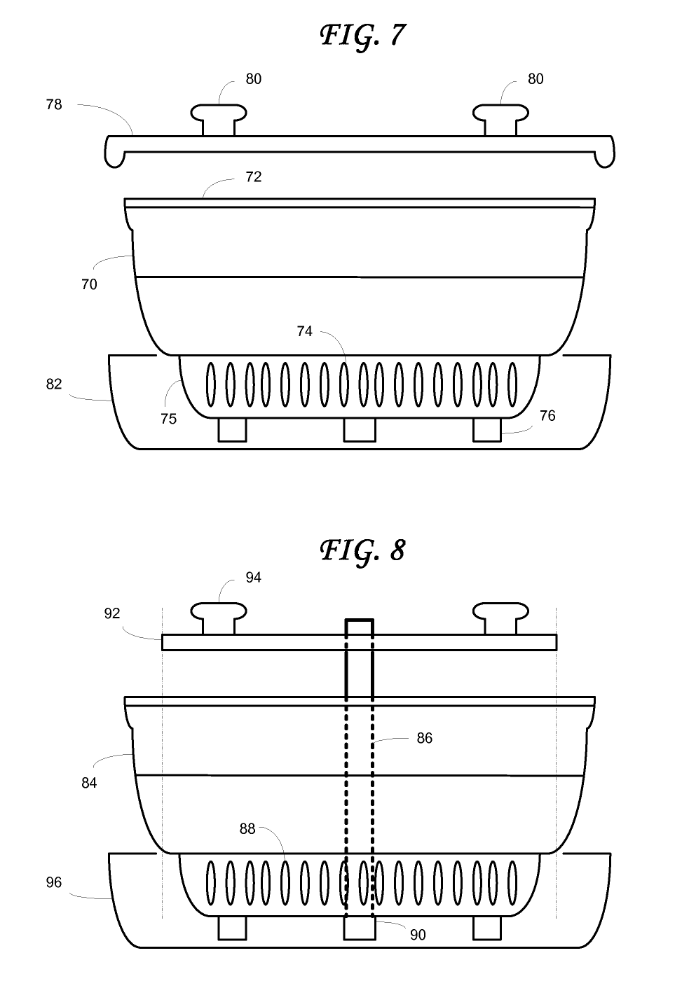

FIG. 7 illustrates another embodiment of a food straining device. In this embodiment, a bowl 70 made from a collapsible food friendly material such as silicone includes a rigid rim portion 72, a rigid bottom portion 75 that includes a plurality of drainage holes 74 and a plurality of base supports 76. An optional catch bowl 82 can be used to retain any liquids that drain from bowl 70 during operation of the food straining device.

A lid component 78 is adapted to fit about rim portion 72 in a sealed manner. The seal could be a Tupperware type lid coupling or a threaded coupling such as that of a nut over a bolt allowing a user to twist and lock the lid component 78 to the rim portion 72 of bowl 70. The lid component further comprises at least one handle element 80 to assist the user in operating the food straining device.

To use the food straining device, a user would load the bowl 70 with a food product such as spinach. The lid 78 would be attached to the rim portion 72 of the bowl 70 using a twist and lock or Tupperware type coupling. The user then grips handle element(s) 80 and pushes downward. Since the body of the bowl is collapsible the lid 78 will compress the food product and force any excess liquid out of the holes 74 at the base of the bowl 70. The optional catch bowl 82 can be used to retain any liquids that drain from bowl 70 during operation.

FIG. 8 illustrates yet another embodiment of a food straining device. In this embodiment, a bowl 84 is made from a rigid plastic food friendly material. The bowl 84 includes a plurality of drainage holes 88 on the lower side near the bottom as well as on the bottom surface (not pictured) and a plurality of base supports 90. The bowl 84 also comprises a post 86 extending upward from the base of the bowl 84 past the top of bowl 84. The post 86 is adapted to work in conjunction with the lid component described further below. An optional catch bowl 96 can be used to retain any liquids that drain from bowl 84 during operation of the food straining device.

A lid component 92 includes a hole in the middle and is adapted to fit about post 86 such that the lid can slide along the length of the post when a downward force is applied. The lid component further comprises at least one handle element 94 to assist the user in operating the food straining device.

To use the food straining device, a user would load the bowl 84 with a food product such as spinach. The lid 92 would be placed about post 86 of the bowl 84. The user then grips handle element(s) 94 and pushes downward. Since the body of the bowl is rigid the lid 78 will slide downward along the post 86 and compress the food product and force any excess liquid out of the holes 88 at the base of the bowl 84. The optional catch bowl 96 can be used to retain any liquids that drain from bowl 84 during operation.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A food straining device comprising:
an upper disc having top and bottom surfaces and including: (i) a plurality of mesh hooks dispersed about the perimeter, (ii) a pair of grips affixed to the top surface, and (iii) a hole bored through the center;
a lower disc having top and bottom surfaces and including: (i) a plurality of non-slip feet affixed to the bottom surface, (ii) a plurality of drainage holes bored through the lower disc, and (iii) a threaded hole bored through the center;
a rod having an upper and lower end in which a handle is integrated into the upper end and the tip of the lower end is threaded, the rod further including: (i) a pair of disc supports capable of supporting the upper disc; and (ii) a disc support release mechanism actuated by a release button integrated into the handle portion of the rod; and
a generally cylindrical mesh bag having upper and lower ends in which the lower end is coupled with the lower disc about its perimeter and the upper end includes a plurality of mesh coupling rings adapted to couple with the plurality of mesh hooks,
wherein the rod is inserted through the hole of the upper disc and is secured in the threaded hole of the bottom disc such that the upper disc rests upon the disc supports.

2. A food straining device comprising:
a collapsible bowl having a rigid rim portion and a rigid base portion, the rigid base portion including a plurality of drainage holes;
a lid component adapted to be coupled with the rigid rim portion of the bowl such that when a food product is present in the bowl and the lid is attached and downward pressure is applied to the lid the bowl will collapse and any excess liquid in the bowl can be squeezed out of the food product through the drainage holes.

3. The food straining device of claim 2 wherein the collapsible bowl is made of silicone.

4. The food straining device of claim 2 wherein the collapsible bowl is made of plastic.

5. The food straining device of claim 2 further comprising a plurality of base supports coupled to the bottom surface of the bowl.

6. The food straining device of claim 2 wherein the lid component further comprises at least one handle element.

7. The food straining device of claim 2 further comprising a catch bowl adapted to receive the collapsible bowl wherein the catch bowl retains liquids that leave the collapsible bowl.

8. A food straining device comprising:
a rigid bowl having a plurality of drainage holes and a post that extends upward from the center of the base of the bowl past the top of the bowl;
a lid component having a hole in its center wherein the hole is adapted to fit over the post such that when a food product is present in the bowl and the lid is fit over the post and downward pressure is applied to the lid the lid will move downward along the post engaging the food product and squeezing any excess liquid in the bowl out of the food product through the drainage holes.

9. The food straining device of claim 8 wherein the rigid bowl is made of food friendly plastic material.

10. The food straining device of claim 8 wherein the rigid bowl is made of food friendly metal material.

11. The food straining device of claim 8 further comprising a plurality of base supports coupled to the bottom surface of the bowl.

12. The food straining device of claim 8 wherein the lid component further comprises at least one handle element.

13. The food straining device of claim 8 further comprising a catch bowl adapted to receive the collapsible bowl wherein the catch bowl retains liquids that leave the collapsible bowl.
